(19) United States
(12) Patent Application Publication
(10) Pub. No.: US 2026/0342220 A1
(43) Pub. Date: Oct. 29, 2026

(54) INTEGRATED MINIATURIZED AVIATION POWER SUPPLY

(71) Applicant: GOODRICH LIGHTING SYSTEMS, INC., Phoenix, AZ (US)

(72) Inventors: Jeffrey Ross Ewanchuk, Manchester, CT (US); Bo Liu, Milford, CT (US); Suman Dwari, Acton, MA (US); Eric Johannessen, Holbrook, NY (US)

(73) Assignee: GOODRICH LIGHTING SYSTEMS, INC., Phoenix, AZ (US)

(21) Appl. No.: 19/540,163

(22) Filed: Feb. 13, 2026

Related U.S. Application Data
(60) Provisional application No. 63/795,474, filed on Apr. 27, 2025.

(51) Int. Cl. H02M 1/42; H02M 1/32

(52) U.S. Cl. CPC H02M 1/4225; H02M 1/32; H02M 1/42

(57) ABSTRACT

An integrated miniaturized aviation power supply is provided for lighting or seat power applications The integrated miniaturized aviation power supply includes a first printed circuit board comprising a first substrate with a first face and a second face opposite the first face, an input coupled to the first face, a plurality of embedded power semiconductors embedded within the first substrate, an embedded power factor correction (PFC) inductor embedded within the first substrate, a transformer partially embedded within the first substrate, a plurality of capacitors coupled to the first face, at least one output inductor partially embedded within the first substrate, and an output coupled to the first face.

### CROSS-REFERENCE TO RELATED APPLICATIONS

This application claims priority to and the benefit of, U.S. Provisional Application No. 63/759,474, filed Feb. 17, 2025, and entitled “INTEGRATED MINIATURIZED AVIATION POWER SUPPLY,” which is incorporated by reference herein in its entirety for all purposes.

### FIELD

The present disclosure generally relates to power supplies, and more specifically, to an integrated miniaturized aviation power supply.

### BACKGROUND

Power supplies generally and, more specifically, related to aviation power systems, feature heterogenous integration of many disparate parts onto a single substrate, i.e., a printed wiring circuit board. However, each component is fabricated individually within its own process domain, i.e., an inductor is either integrated in a separate process wherein the windings are wound in a core, the inductor is then packaged and mounted onto the power supply substrate. Hence, the pace of power supply miniaturization is therefore dependent on the technology of the component and the interconnection development.

Alternatively, if instead of integrating the packaged power semiconductors, magnetic filters, and filter capacitors separately with discrete components, the power supply were to integrate within the substrate with more fundamental technology, i.e., the bare power semiconductor components, the raw magnetic material and capacitors, the miniaturization of the power supply would occur solely in pace with the material development and not with the interconnection technology development pace.

Moreover, low power supplies, i.e., those that are used in lighting power systems, are comprised of many discrete components dedicating to filter to provide high power quality during the conversion process. While power magnetic components are typically wound on a magnetic core to realize the inductive components, manual winding of each component increases their cost and limits precise control over the stray parameters, i.e., the leakage inductance for a transformer or the capacitance.

Planar magnetics, on the other hand, employ wide aspect ratio magnetic cores, with enable printed circuit board (PCB) based windings to help realize the design. In this case, the stray values are easy to control with high manufacturability. However, planar inductors remain difficult to realize effectively in PCB technology, as inductors do not benefit from interleaving to reduce losses, and hence, the only feasible approach to creating low loss planar inductor is to limit each turn to one layer. Necessarily though, in high voltage inductors, this becomes impossible as the required number of turns would limit the economic feasibility of the PCB stack up.

### SUMMARY

Disclosed herein is an integrated miniaturized aviation power supply. The integrated miniaturized aviation power supply includes a first printed circuit board comprising a first substrate with a first face and a second face opposite the first face, an input coupled to the first face, a plurality of embedded power semiconductors embedded within the first substrate, an embedded power factor correction (PFC) inductor embedded within the first substrate, a transformer partially embedded within the first substrate, a plurality of capacitors coupled to the first face, at least one output inductor partially embedded within the first substrate, and an output coupled to the first face.

In various embodiments, the plurality of capacitors are at least one of embedded within the first substrate or externally coupled to the first face.

In various embodiments, each embedded power semiconductor of the plurality of embedded power semiconductors is configured to provide electrical connectivity via one or more conductive metal contacts positioned on at least one of the first face or the second face via at least one microvia.

In various embodiments, the embedded power factor correction (PFC) inductor includes a power factor correction magnetic filter material embedded within the first substrate, a plurality of windings embedded within the first substrate and wound around the power factor correction magnetic filter material, a PFC input to a first contact on the first face via a first microvia, and a PFC output to a second contact on the first face via a second microvia.

In various embodiments, the transformer includes a plurality of first windings embedded within the first substrate, a plurality of second windings embedded within the first substrate and adjacent the plurality of first windings, and a magnetic core coupled to the first face and the second face of the first substrate and positioned adjacent to the plurality of first windings and the plurality of second windings.

In various embodiments, the at least one output inductor includes a plurality of windings embedded within the first substrate, and a magnetic core coupled to the first face of the first substrate and positioned adjacent to the plurality of windings.

In various embodiments, the magnetic core is at least one of an E-E core or an E-I core and wherein the plurality of windings are configured to wrap around an inner limb of the magnetic core.

In various embodiments, the magnetic core is at least one of an E-E core or an E-I core and wherein the plurality of windings are configured to wrap around outer limbs of the magnetic core.

In various embodiments, the integrated miniaturized aviation power supply further includes a second printed circuit board comprising second substrate with a first face and a second face opposite the first face, at least one electronic component coupled to the first face of the second substrate, and a flexible interconnection formed between the first printed circuit board and the second printed circuit board. In various embodiments, the flexible interconnection comprises polyimide layers with thin conductive metal connections configured to electrically couple the second printed circuit board to the first printed circuit board.

In various embodiments, the second printed circuit board is configured to be folded over the first printed circuit board such that the at least one electronic component coupled to the first face of the second substrate is free from interference with any components on the first printed circuit board.

Also disclosed herein is an aircraft. The aircraft includes an electric component configured to receive and output voltage, a power source configured to supply an input voltage, and an integrated miniaturized aviation power supply configured to receive the input voltage and output the output voltage. The integrated miniaturized aviation power supply includes a first printed circuit board comprising a first substrate with a first face and a second face opposite the first face, an input coupled to the first face, a plurality of embedded power semiconductors embedded within the first substrate, an embedded power factor correction (PFC) inductor embedded within the first substrate, a transformer partially embedded within the first substrate, a plurality of capacitors coupled to the first face, at least one output inductor partially embedded within the first substrate, and an output coupled to the first face.

In various embodiments, the plurality of capacitors are at least one of embedded within the first substrate or externally coupled to the first face.

In various embodiments, each embedded power semiconductor of the plurality of embedded power semiconductors is configured to provide electrical connectivity via one or more conductive metal contacts positioned on at least one of the first face or the second face via at least one microvia.

In various embodiments, the embedded power factor correction (PFC) inductor includes a power factor correction magnetic filter material embedded within the first substrate, a plurality of windings embedded within the first substrate and wound around the power factor correction magnetic filter material, a PFC input to a first contact on the first face via a first microvia, and a PFC output to a second contact on the first face via a second microvia.

In various embodiments, the transformer includes a plurality of first windings embedded within the first substrate, a plurality of second windings embedded within the first substrate and adjacent the plurality of first windings, and a magnetic core coupled to the first face and the second face of the first substrate and positioned adjacent to the plurality of first windings and the plurality of second windings.

In various embodiments, the at least one output inductor includes a plurality of windings embedded within the first substrate, and a magnetic core coupled to the first face of the first substrate and positioned adjacent to the plurality of windings.

In various embodiments, the magnetic core is at least one of an E-E core or an E-I core and wherein the plurality of windings are configured to wrap around an inner limb of the magnetic core.

In various embodiments, the magnetic core is at least one of an E-E core or an E-I core and wherein the plurality of windings are configured to wrap around outer limbs of the magnetic core.

In various embodiments, the integrated miniaturized aviation power supply further includes a second printed circuit board comprising second substrate with a first face and a second face opposite the first face, at least one electronic component coupled to the first face of the second substrate, and a flexible interconnection formed between the first printed circuit board and the second printed circuit board. In various embodiments, the flexible interconnection comprises polyimide layers with thin conductive metal connections configured to electrically couple the second printed circuit board to the first printed circuit board.

In various embodiments, the second printed circuit board is configured to be folded over the first printed circuit board such that the at least one electronic component coupled to the first face of the second substrate is free from interference with any components on the first printed circuit board.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a power supply on an integrated printed circuit board (PCB) where various electronic components are combined within a single substrate to perform the power conversion process in an aviation-based lighting system, in accordance with various embodiments.

FIG. 2A illustrates an embedded power semiconductor, in accordance with various embodiments.

FIG. 2B illustrates an embedded PFC inductor, in accordance with various embodiments.

FIG. 2C illustrates a partially embedded transformer or a partially embedded output inductor, in accordance with various embodiments.

FIG. 3 illustrates an integrated aviation power supply with first substrate and a second substrate coupled together via a flexible segment and configured to be folded together to reduce the total area of the power supply, in accordance with various embodiments.

FIG. 4 illustrates heat-spreading structures laminated to a second face of a first PCB and to a second face of a second PCB, in accordance with various embodiments.

FIG. 5 illustrates an exemplary power supply schematic, in accordance with various embodiments.

FIG. 6 illustrates a high-turn count planar inductor with windings around the inner limb, in accordance with various embodiments.

FIG. 7 illustrates another exemplary power supply schematic with windings of the output inductor being co-located to the outer limbs, in accordance with various embodiments.

FIG. 8 illustrates a high-turn count planar inductor with windings around the outer limbs with N/2 turns with φ/2 flux and φ flux in the center, in accordance with various embodiments.

FIG. 9 illustrates an adjustment of a number of turns per side limb to provide an increased common mode inductance without compromising the differential mode inductance, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Auxiliary power systems in aviation applications, such as lighting or in seat control systems, have a major contribution to the overall power system weight due to the number of these converters. Hence, miniaturization of these power supplies while still maintaining high power conversion efficiencies is important for future system cost competitiveness. However, low power conversion systems are typically dominated in surface area and volume by the discrete component technology, and their interconnections to the common power board.

Additionally, planar magnetics provide an advantage in terms of power density and cost. However, the fabrication of planar inductors is difficult due to the large number of turns needed to achieve a target inductance, as these components also employ air gaps to store magnetic energy. Thus, as interleaving is not possible, the utilization of the copper within the planar inductor window is poor, which results in relatively high losses. Further, due to the large number of turns, the printed circuit board (PCB) stack up designs are not cost effective.

As discussed hereafter, in various embodiments, composite power semiconductors and power magnetics of a low power converter circuit are integrated into a single substrate, i.e., a printed circuit board, to achieve a small form factor. In various embodiments, the power semiconductors are embedded within the stack of the substrate, the output and transformer windings are integrated within assembly, while the power factor correction inductor in the AC/DC conversion stage is integrated with an embedded toroid core. In various embodiments, a flexible interconnection is integrated to allow more bulky components that cannot be well integrated into the substate the ability to fold over the main substrate. In various embodiments, a heat-spreader is integrated into each of the substrates used in the power converter.

In various embodiments, a modification to the planar inductor winding structure is provided to reduce the required PCB stack up by half, by re-locating the embedded inductor windings to the outside limb. In various embodiments, while this improves manufacturability, and performance, one key aspect is that, by splitting the windings on each limb, common mode impedance increases by introducing a symmetric impedance to each positive and negative rail. Further, in various embodiments, by offsetting the limb windings, the common mode inductance may be further optimized to provide weight savings.

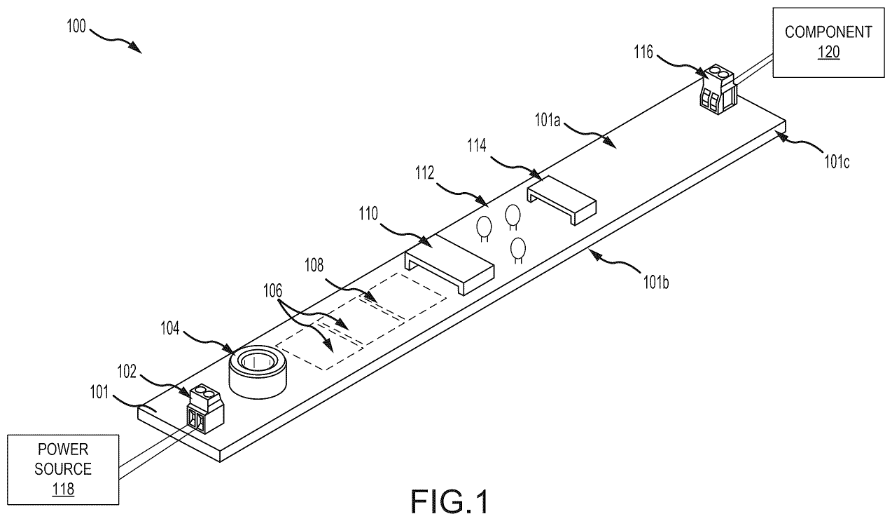

Referring now to FIG. 1, a power supply on an integrated printed circuit board (PCB) where various electronic components are combined within a single substrate to perform the power conversion process in an aviation-based lighting system is illustrated, in accordance with various embodiments. In various embodiments, the power supply 100 formed on and within the integrated PCB 101. In that regard, in various embodiments, the PCB 101 has structured layers between a first face 101a and a second face 101b opposite the first face 101a. In various embodiments, the structured layers include one or more of a substrate 101c, conductive material traces, and a solder mask, among others. In various embodiments, the substrate 101c is formed from a dielectric. In various embodiments, the conductive metal traces may be one or more of copper, silver, or nickel, among others. In various embodiments, various electronic components may be coupled to the first face 101a and/or the second face 101b and coupled together via the conductive metal traces and/or conductive metal vias that protrude through the substrate 101c from the first face 101a to the second face 101b. In various embodiments, the conductive metal vias may be one or more of copper, silver, or nickel, among others.

In various embodiments, the PCB 101 includes one or more of an input 102, an electromagnetic interference (EMI) filter 104 coupled to the first face 101a, various embedded power semiconductors 106 embedded within the substrate 101c, i.e. such as switches and diodes, at least one embedded power factor correction (PFC) inductor 108 embedded within the substrate 101c, a transformer 110 partially embedded within the substrate 101c, various capacitors 112, which may be embedded within the substrate 101c or externally coupled to first face 101a, at least one output inductor 114 partially embedded within the substrate 101c, and an output 116. In various embodiments, a power source 118 is configured to deliver a voltage, such as between 110 Volts alternating current (AC) and 120 Volts AC to the input 102. In various embodiments, the input voltage is passed through the EMI filter 104. In that regard, in various embodiments, the EMI filter 104, which may be composed of single stage inductor (L) capacitor (C) (LC) or a two-stage LCLC filter combination, among other combinations, is configured to block unwanted high-frequency noise in the input power delivered via input 102.

In various embodiments, the input 102 is coupled a bridge rectifier formed from a subset of the various embedded power semiconductors 106. In various embodiments, the bridge rectifier is configured to convert the AC voltage to a direct current (DC) voltage and deliver the DC voltage to a power conversion stage. In various embodiments, the power conversion stage, which includes the embedded PFC inductor 108 as well as a switch and a diode from the various embedded power semiconductors 106 is configured to convert the DC voltage from the bridge rectifier to between 200 Volts DC and 300 Volts DC with close to a unity power factor.

In various embodiments, the DC voltage of 200-300V DC from the power conversion stage is converted to a secondary output voltage of 10-30V DC using a DC/DC converter, i.e., using an active clamp forward converter with an inductor and capacitor output. In that regard, the active clamp forward converter includes a set of capacitors from the various capacitors 112 and a switch from the various embedded power semiconductors 106 on the high voltage side, the transformer 110, a set of diodes from the various embedded power semiconductors 106, the output inductor 114, and a capacitor from the various capacitors 112 on the low voltage side configured to deliver the secondary output voltage of 10-30V DC to the output 116, which is coupled to a component 120, i.e. a lighting system, that utilizes the output voltage of the power supply 100.

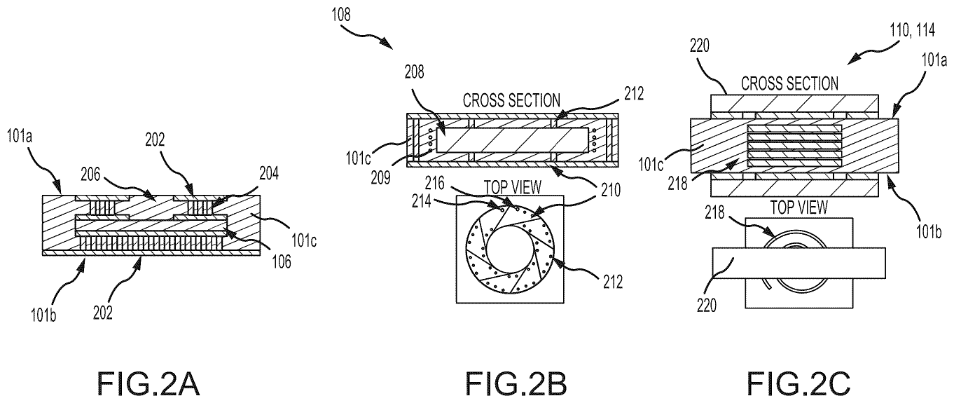

Referring now to FIG. 2A an embedded power semiconductor is illustrated, in accordance with various embodiments. In various embodiments, each of the various embedded power semiconductors 106 is embedded within the substrate 101c. In various embodiments, electrical connectivity to each of the embedded power semiconductors 106 is provided via conductive metal contact(s) 202 positioned on the first face 101a and/or the second face 101b via conductive metal microvias 204. In various embodiments, the conductive metal contact(s) 202 and the conductive metal microvias 204 may be one or more of copper, silver, or nickel, among others. In various embodiments, the various embedded power semiconductors 106, the conductive metal microvias 204 and inward facing portions of the conductive metal contact(s) 202 are insulated via a dielectric 206 of the substrate 101c of the integrated PCB 101.

Referring now to FIG. 2B, an embedded PFC inductor is illustrated, in accordance with various embodiments. As illustrated in FIG. 2B, in various embodiments, the power factor correction magnetic filter material, i.e., ferrite 208, used for the embedded PFC inductor 108 may be 1-3 mm thick in a toroidal shape and is embedded within the stack-up of the substrate 101c of the integrated PCB 101 with the windings 209 being formed within the substrate 101c of the integrated PCB 101 itself, i.e., with conductive metal contact(s) 210 and conductive metal microvias 212. In various embodiments, the conductive metal contact(s) 210 and the conductive metal microvias 212 may be one or more of copper, silver, or nickel, among others. In various embodiments, a PFC input 214 and a PFC output 216 are provided via the conductive metal contact(s) 210 for exterior coupling to the embedded PFC inductor 108. In various embodiments, the embedded PFC inductor 108 is integrated in this manner as the embedded PFC inductor 108 typically requires many series connected turns compared to the transformer 110 or the output inductor 114.

Referring now to FIG. 2C, a partially embedded transformer or a partially embedded output inductor is illustrated, in accordance with various embodiments. In various embodiments, the transformer 110 for the DC/DC converter stage and the output inductor 114 are configured to include windings 218 or sets of windings 218 adjacent to one another that are embedded within the substrate 101c of the integrated PCB 101 with the magnetic core 220, i.e., a ferrite core, inserted onto the first face 101a and/or the second face 101b of the substrate 101c and positioned adjacent to the windings 218.

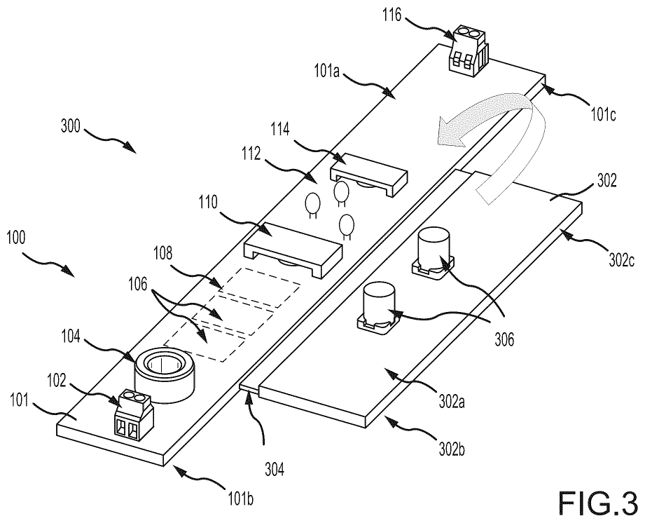

Referring now to FIG. 3, an integrated aviation power supply with first substrate and a second substrate coupled together via a flexible segment and configured to be folded together to reduce the total area of the power supply is illustrated, in accordance with various embodiments. In various embodiments, the power supply 300 includes the power supply 100 of FIG. 1 coupled to a second PCB 302 via a flexible interconnection 304. In various embodiments, the second PCB 302 has structured layers between a first face 302a and a second face 302b opposite the first face 302a. In various embodiments, the structured layers include one or more of a substrate 302c, conductive metal traces, and a solder mask, among others. In various embodiments, the substrate 302c is formed from a dielectric. In various embodiments, various electronic components may be coupled to the first face 302a and/or the second face 302b and coupled together via the conductive metal traces and/or conductive metal vias that protrude through the substrate 302c from the first face 302a to the second face 302b. In various embodiments, depending on the implementation of the power supply 100, some of the capacitance required by the power supply 100 may be larger than that provided by the various capacitors 112, i.e., the capacitance may require electrolytic capacitors 306, which may not be easily integrated within the substrate 101c because of their size. Accordingly, in various embodiments, the electrolytic capacitors 306 are coupled to the first face 302a of the second PCB 302 and via one or more conductive metal traces and/or conductive metal vias may be electrically coupled to the PCB 101 via the flexible interconnection 304. In that regard, in various embodiments, the flexible interconnection 304 may include polyimide layers with thin conductive metal connections configured to electrically couple the second PCB 302 to the PCB 101. In various embodiments, in order to reduce the total area of the power supply 300 utilizing the flexible interconnection 304, the second PCB 302 is then configured to be folded over the PCB 101 such that the electrolytic capacitors 306 do not interfere with any other components on the PCB 101.

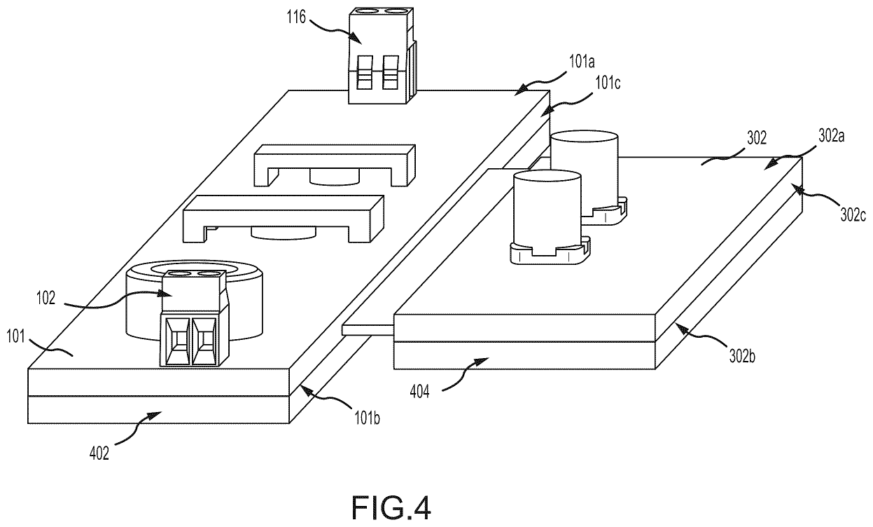

Referring now to FIG. 4, heat-spreading structures laminated to a second face of a first PCB and to a second face of a second PCB are illustrated, in accordance with various embodiments. In various embodiments, the substrate 101c of the PCB 101 integrates components that produce heat and therefore may benefit from heatsinking to ambient air. In various embodiments, the substrate 302c of the second PCB 302 may also integrate components that produce heat and therefore may benefit from heatsinking to ambient air. In that regard, in various embodiments, the substrate 101c of the PCB 101 may be laminated with a heat-spreading structure 402 mechanically coupled to the substrate 101c. In various embodiments, the heat-spreading structure 402 may be a dielectric material, i.e., a cold plate or aluminum plate.

In that regard, in various embodiments, the substrate 302c of the second PCB 302 may be laminated with a heat-spreading structure 404 mechanically coupled to the substrate 302c. In various embodiments, the heat-spreading structure 404 may be a dielectric material, i.e., a metallic heat sink.

Accordingly, in various embodiments, with regard to FIGS. 1, 2A, 2B, and 2C, an integration of power magnetic and semiconductor components on a single substrate for aviation power supply operations is provided. In various embodiments, with regard to FIGS. 3 and 4, a flexible interconnection region may interconnect an additional rigid substrate to form a single folded high power density power supply. In various embodiments, each substrate may be further combined with a heat-spreading feature that may be processed with the substrate to provide cooling. In various embodiments, the discrete interconnections between many space limiting components are removed, thereby allowing more compact power supplies with a lower cost. In various embodiments, the direct material integration enables better performance optimization as compared with packaged components for power supply applications. In various embodiments, the integration of the major power components is important to remove the interconnections of otherwise discrete components. Accordingly, in various embodiments, using the proposed architecture, cost effective and miniaturized low power supplies for lighting or seat power applications may be realized.

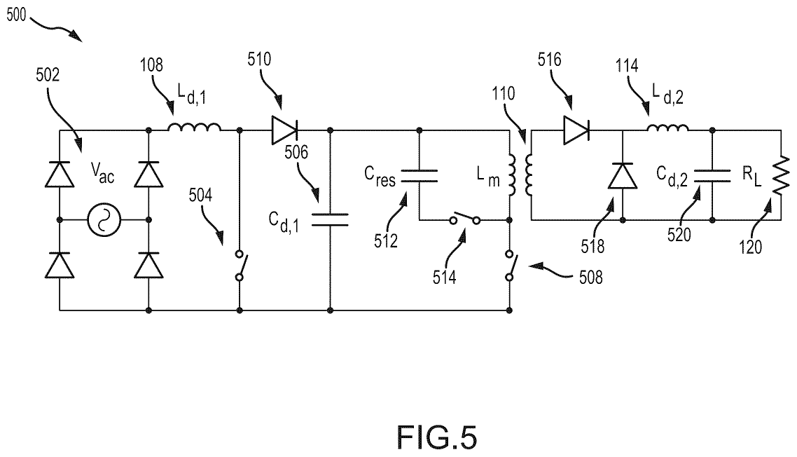

Referring now to FIG. 5, an exemplary power supply schematic is illustrated, in accordance with various embodiments. In various embodiments, the exemplary power supply 500 includes a bridge rectifier 502 configured to receive an alternating current (AC) voltage and provide a direct current (DC) output voltage. In various embodiments, a first output of the bridge rectifier 502 is electrically coupled to a first side of an embedded PFC inductor 108 of FIG. 1. In various embodiments, the second output of the bridge rectifier 502 is electrically coupled to a first side of a first switch 504, a first capacitor 506, and a second switch 508. In various embodiments, each of the bridge rectifier 502, the first switch 504, and the second switch 508 may be one of the various embedded power semiconductors 106 of FIG. 1. In various embodiments, the first capacitor 506 may be one of the various capacitors 112 of FIG. 1.

In various embodiments, a second side of the embedded PFC inductor 108 is electrically coupled to a second side of the first switch 504 and a first side of a first diode 510. In various embodiments, the first diode 510 may be one of the various embedded power semiconductors 106 of FIG. 1. In various embodiments, a second side of the first diode 510 is electrically coupled to the first capacitor 506, a first side of a second capacitor 512, and a first side of a high-voltage side of the transformer 110 of FIG. 1. In various embodiments, the second capacitor 512 may be one of the various capacitors 112 of FIG. 1. In various embodiments, the second side of the second switch 508 is electrically coupled to a second side of the high-voltage side of the transformer 110 and a first side of a second switch 514. In various embodiments, the second switch 514 may be one of the various embedded power semiconductors 106 of FIG. 1. In various embodiments, a second side of the second switch 514 is electrically coupled to a second side of the second capacitor 512.

In various embodiments, a first side of a low-voltage side of the transformer 110 is electrically coupled to a first side of a second diode 516. In various embodiments, the second diode 516 may be one of the various embedded power semiconductors 106 of FIG. 1. In various embodiments, a second side of a low-voltage side of the transformer 110 is electrically coupled to a first side of a third diode 518, a first side of third capacitor 520, and a component 120 of FIG. 1. In various embodiments, the third diode 518 may be one of the various embedded power semiconductors 106 of FIG. 1. In various embodiments, the third capacitor 520 may be one of the various capacitors 112 of FIG. 1. In various embodiments, a second side of the second diode 516 and a second side of the third diode 518 is electrically coupled to a first side of the output inductor 114 of FIG. 1. In various embodiments, the second side of the output inductor 114 is electrically coupled to a second side of the third capacitor 520 and the component 120.

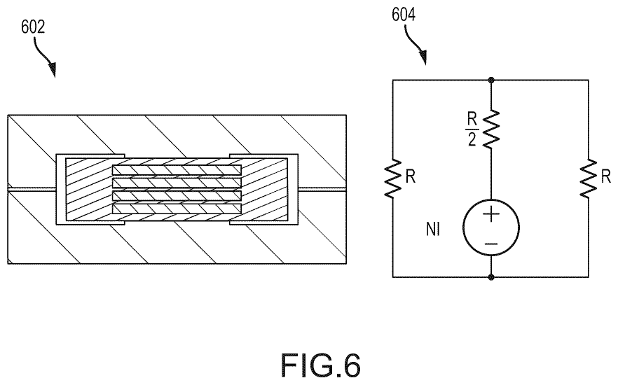

Referring now to FIG. 6, a high-turn count planar inductor is illustrated with windings around the inner limb, in accordance with various embodiments. More specifically, in various embodiments, the inductor 602 of FIG. 6 and its resulting flux equivalent magnetic model 604 provides a planar inductor with a E-E or E-I core set that may be used to form the output inductor 114 of FIGS. 1, 3, or 5. In various embodiments, the turns or windings of the output inductor 114 to achieve a desired filtered inductance, Ld, is N, resulting in φ flux and Bm flux density in the center leg. It is noted that the inductor 602 has one input and one output and thus, inductor 602 may be located in either a positive current pathway or a negative current pathway, but not both.

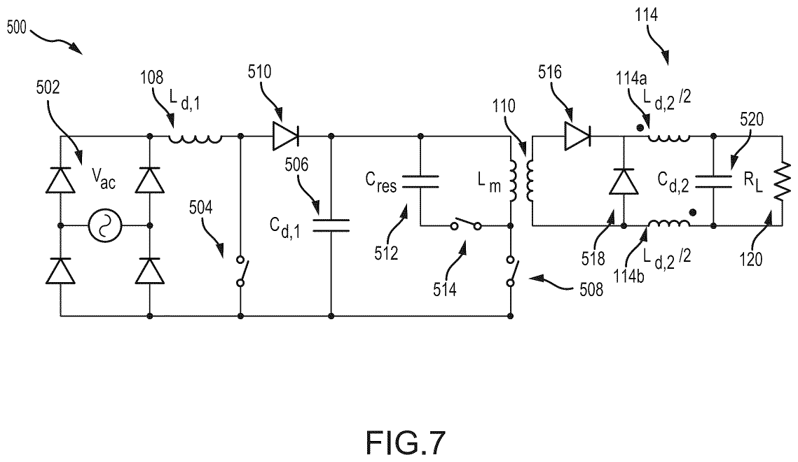

Referring now to FIG. 7, another exemplary power supply schematic with windings of the output inductor being co-located to the outer limbs is illustrated, in accordance with various embodiments. In various embodiments, the exemplary power supply 500 includes a bridge rectifier 502 configured to receive an alternating current (AC) voltage and provide a direct current (DC) output voltage. In various embodiments, a first output of the bridge rectifier 502 is electrically coupled to a first side of an embedded PFC inductor 108 of FIG. 1. In various embodiments, the second output of the bridge rectifier 502 is electrically coupled to a first side of a first switch 504, a first capacitor 506, and a second switch 508. In various embodiments, each of the bridge rectifier 502, the first switch 504, and the second switch 508 may be one of the various embedded power semiconductors 106 of FIG. 1. In various embodiments, the first capacitor 506 may be one of the various capacitors 112 of FIG. 1.

In various embodiments, a second side of the embedded PFC inductor 108 is electrically coupled to a second side of the first switch 504 and a first side of a first diode 510. In various embodiments, the first diode 510 may be one of the various embedded power semiconductors 106 of FIG. 1. In various embodiments, a second side of the first diode 510 is electrically coupled to the first capacitor 506, a first side of a second capacitor 512, and a first side of a high-voltage side of the transformer 110 of FIG. 1. In various embodiments, the second capacitor 512 may be one of the various capacitors 112 of FIG. 1. In various embodiments, the second side of the second switch 508 is electrically coupled to a second side of the high-voltage side of the transformer 110 and a first side of a second switch 514. In various embodiments, the second switch 514 may be one of the various embedded power semiconductors 106 of FIG. 1. In various embodiments, a second side of the second switch 514 is electrically coupled to a second side of the second capacitor 512.

In various embodiments, a first side of a low-voltage side of the transformer 110 is electrically coupled to a first side of a second diode 516. In various embodiments, the second diode 516 may be one of the various embedded power semiconductors 106 of FIG. 1. In various embodiments, a second side of a low-voltage side of the transformer 110 is electrically coupled to a first side of a third diode 518 and a first side of a first winding 114b of a split winding output inductor 114. In various embodiments, the second side of the first winding 114b of a split winding output inductor 114 is electrically coupled to a first side of third capacitor 520 and a component 120 of FIG. 1. In various embodiments, the third diode 518 may be one of the various embedded power semiconductors 106 of FIG. 1. In various embodiments, the third capacitor 520 may be one of the various capacitors 112 of FIG. 1. In various embodiments, a second side of the second diode 516 and a second side of the third diode 518 is electrically coupled to a first side of a second winding 114a of the split winding output inductor 114 of FIG. 1. In various embodiments, the second side of the second winding 114a of the split winding output inductor 114 is electrically coupled to a second side of the third capacitor 520 and the component 120.

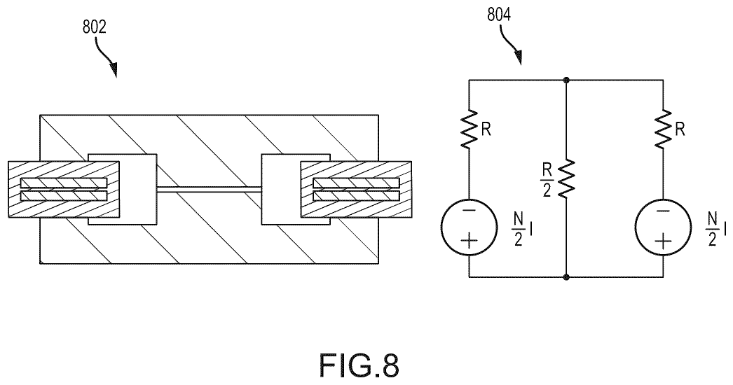

Referring now to FIG. 8, a high-turn count planar inductor is illustrated with windings around the outer limbs with N/2 turns with φ/2 flux and φ flux in the center, in accordance with various embodiments. In various embodiments, the inductor 802 and its resulting flux equivalent magnetic model 804 illustrate the core limbs on the outside of the inductor 802 have half the width of the center limb, giving Bm flux density in all legs. In various embodiments, each coil on the outer limb is fed by the same current as in the center limb case. In various embodiments, the total inductance, Ld, is the same as with N turns, but each limb locally sees Ld/2 inductance, as per FIG. 7. In various embodiments, the resulting flux paths are shown in FIG. 8, which are identical to the original winding with the center limb, as per FIG. 6. In various embodiments, as the inductance paths are symmetric, common mode currents are inherently restrained. In various embodiments, the resulting inductance Ld is integrated with half of the number of PCB layers, making the planar inductor more manufacturable.

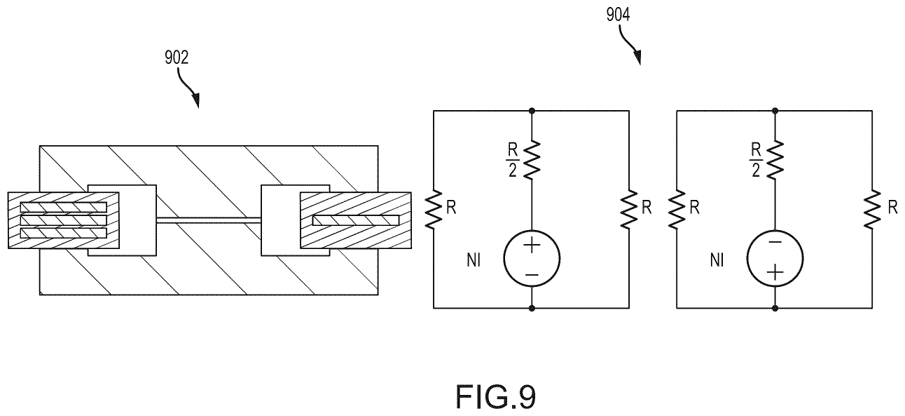

Referring now to FIG. 9, an adjustment of a number of turns per side limb is illustrated to provide an increased common mode inductance without a significant change to the differential mode inductance, in accordance with various embodiments. In various embodiments, the inductor 902 and its resulting flux equivalent magnetic model 904 are illustrated. In various embodiments, given the total inductance, Ld, with N turns split across two outside limbs, an offset of +n and −n is added to either limb. In various embodiments, in the differential excitation, i.e., normal operation in a power factor correction circuit, the inductance is not changed. In various embodiments, when excited in the same current direction for each winding, i.e., a common mode excitation, a common mode reluctance path now exists in the core. In various embodiments, when n=0, the common mode inductance is depending on each windings leakage inductance path only and does not induce common mode flux in the core.

Accordingly, in various embodiments, manufacturability and performance (lower losses) may be improved by a simple winding modification. A tradeoff is in winding area, but with embedded windings, additional winding area is not a concern. In various embodiments, one important aspect is the ability to then enable common mode impedance, which would otherwise only be handled by the EMI filter. In various embodiments, the common mode inductance may be specifically designed into an otherwise differential mode only filter inductor by further offsetting the windings. In various embodiments, a number of layers for a given inductor design is halved thereby simplifying the manufacturing and cost of the assembly. In various embodiments, a window area per coil may be maximized for a given design, thereby resulting to the lowest losses possible for a planar inductor design. In various embodiments, vias can also be removed from the window without a performance penalty. In various embodiments, common mode filtering from each inductor enables a size and weight reduction at the system level due to lower common mode filter requirements, which means that part of the EMI filter is integrated into the proposed differential mode inductor. Accordingly, in various embodiments, benefits of the illustrative embodiments are lower losses within a planar inductor assembly, but with improved manufacturability. In various embodiments, a unique and non-obvious benefit is achieved by enabling a common mode impedance, either by the leakage inductance or the offset winding to lower the total system weight by reducing the EMI filter requirements.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An integrated miniaturized aviation power supply, comprising:
a first printed circuit board comprising a first substrate with a first face and a second face opposite the first face;
an input coupled to the first face;
a plurality of embedded power semiconductors embedded within the first substrate;
an embedded power factor correction (PFC) inductor embedded within the first substrate;
a transformer partially embedded within the first substrate;
a plurality of capacitors coupled to the first face;
at least one output inductor partially embedded within the first substrate; and
an output coupled to the first face.

2. The integrated miniaturized aviation power supply of claim 1, wherein the plurality of capacitors are at least one of embedded within the first substrate or externally coupled to the first face.

3. The integrated miniaturized aviation power supply of claim 1, wherein each embedded power semiconductor of the plurality of embedded power semiconductors is configured to provide electrical connectivity via one or more conductive metal contacts positioned on at least one of the first face or the second face via at least one microvia.

4. The integrated miniaturized aviation power supply of claim 1, wherein the embedded power factor correction (PFC) inductor comprises:
a power factor correction magnetic filter material embedded within the first substrate;
a plurality of windings embedded within the first substrate and wound around the power factor correction magnetic filter material;
a PFC input to a first contact on the first face via a first microvia; and
a PFC output to a second contact on the first face via a second microvia.

5. The integrated miniaturized aviation power supply of claim 1, wherein the transformer comprises:
a plurality of first windings embedded within the first substrate;
a plurality of second windings embedded within the first substrate and adjacent the plurality of first windings; and
a magnetic core coupled to the first face and the second face of the first substrate and positioned adjacent to the plurality of first windings and the plurality of second windings.

6. The integrated miniaturized aviation power supply of claim 1, wherein the at least one output inductor comprises:
a plurality of windings embedded within the first substrate; and
a magnetic core coupled to the first face of the first substrate and positioned adjacent to the plurality of windings.

7. The integrated miniaturized aviation power supply of claim 6, wherein the magnetic core is at least one of an E-E core or an E-I core and wherein the plurality of windings are configured to wrap around an inner limb of the magnetic core.

8. The integrated miniaturized aviation power supply of claim 6, wherein the magnetic core is at least one of an E-E core or an E-I core and wherein the plurality of windings are configured to wrap around outer limbs of the magnetic core.

9. The integrated miniaturized aviation power supply of claim 1, further comprising:
a second printed circuit board comprising second substrate with a first face and a second face opposite the first face;
at least one electronic component coupled to the first face of the second substrate; and
a flexible interconnection formed between the first printed circuit board and the second printed circuit board, wherein the flexible interconnection comprises polyimide layers with thin conductive metal connections configured to electrically couple the second printed circuit board to the first printed circuit board.

10. The integrated miniaturized aviation power supply of claim 9, wherein the second printed circuit board is configured to be folded over the first printed circuit board such that the at least one electronic component coupled to the first face of the second substrate is free from interference with any components on the first printed circuit board.

11. An aircraft, comprising:
an electric component configured to receive and output voltage;
a power source configured to supply an input voltage; and
an integrated miniaturized aviation power supply configured to receive the input voltage and output the output voltage, the integrated miniaturized aviation power supply comprising:
a first printed circuit board comprising a first substrate with a first face and a second face opposite the first face;
an input coupled to the first face;
a plurality of embedded power semiconductors embedded within the first substrate;
an embedded power factor correction (PFC) inductor embedded within the first substrate;
a transformer partially embedded within the first substrate;
a plurality of capacitors coupled to the first face;
at least one output inductor partially embedded within the first substrate; and
an output coupled to the first face.

12. The aircraft of claim 11, wherein the plurality of capacitors are at least one of embedded within the first substrate or externally coupled to the first face.

13. The aircraft of claim 11, wherein each embedded power semiconductor of the plurality of embedded power semiconductors is configured to provide electrical connectivity via one or more conductive metal contacts positioned on at least one of the first face or the second face via at least one microvia.

14. The aircraft of claim 11, wherein the embedded power factor correction (PFC) inductor comprises:
a power factor correction magnetic filter material embedded within the first substrate;
a plurality of windings embedded within the first substrate and wound around the power factor correction magnetic filter material;
a PFC input to a first contact on the first face via a first microvia; and
a PFC output to a second contact on the first face via a second microvia.

15. The aircraft of claim 11, wherein the transformer comprises:
a plurality of first windings embedded within the first substrate;
a plurality of second windings embedded within the first substrate and adjacent the plurality of first windings; and
a magnetic core coupled to the first face and the second face of the first substrate and positioned adjacent to the plurality of first windings and the plurality of second windings.

16. The aircraft of claim 11, wherein the at least one output inductor comprises:
a plurality of windings embedded within the first substrate; and
a magnetic core coupled to the first face of the first substrate and positioned adjacent to the plurality of windings.

17. The aircraft of claim 16, wherein the magnetic core is at least one of an E-E core or an E-I core and wherein the plurality of windings are configured to wrap around an inner limb of the magnetic core.

18. The aircraft of claim 16, wherein the magnetic core is at least one of an E-E core or an E-I core and wherein the plurality of windings are configured to wrap around outer limbs of the magnetic core.

19. The aircraft of claim 11, further comprising:
a second printed circuit board comprising second substrate with a first face and a second face opposite the first face;
at least one electronic component coupled to the first face of the second substrate; and
a flexible interconnection formed between the first printed circuit board and the second printed circuit board, wherein the flexible interconnection comprises polyimide layers with thin conductive metal connections configured to electrically couple the second printed circuit board to the first printed circuit board.

20. The aircraft of claim 19, wherein the second printed circuit board is configured to be folded over the first printed circuit board such that the at least one electronic component coupled to the first face of the second substrate is free from interference with any components on the first printed circuit board.
